(19) United States
(12) Patent Application Publication
(10) Pub. No.: US 2023/0124387 A1
(43) Pub. Date: Apr. 20, 2023

(54) SERVER PERFORMANCE AND APPLICATION HEALTH MANAGEMENT SYSTEM AND METHOD

(71) Applicant: Fortified Insight, LLC, Fort Mill, SC (US)

(72) Inventors: Ben DeBow, Fort Mill, SC (US); Adi Cohen, Woodinville, WA (US)

(21) Appl. No.: 17/504,036

(22) Filed: Oct. 18, 2021

(51) Int. Cl. G06F 9/50

(52) U.S. Cl. CPC G06F 9/5083; G06Q 10/0639

(57) ABSTRACT

A management system for server analysis gives users algorithmically generated metrics representing the performance of servers and the health of executed applications on the servers or the health of serverless applications. The metrics generated are related to server and/or application capacity and application workload health. Server capacity metrics include those related to CPU, storage memory, and volatile memory resources. Application capacity metrics include those related to resource contention, the processor, storage, and memory of the application. Also, the monitoring system shows metrics related to the reliability, stability, and predictability of an application to analyze the workload health of an application. The scores are easily interpretated, by experts or non-experts, to identify problems, improvements, and solutions. The user-friendly scores make monitoring, management, maintenance, and scheduling of processes simpler and more accurate.

### FIELD

The present invention is related generally to servers, applications on servers or, serverless applications. More specifically, the present invention is related to a system and method for managing the performance, capacity, and health of one or more of a server, application on a server, or serverless application.

### BACKGROUND OF THE INVENTION

Servers are an integral part of a modern economy and society. Servers provide the backbone of the internet and major business networks, handling requests for and returns of information, and providing clients access to a number of services, such as accessing a webpage, sending an email, and downloading a file. Therefore, the health and performance of server systems are important.

Analysis of the health and performance of a server system is necessary to manage a server system and often involves in-depth and complex monitoring of numerous complicated server-resource indicators over time. Correct and efficient analyses can lead to more efficient and productive use of server resources, optimizing client costs and providing system reliability and stability. However, the complexity of monitoring itself often prevents correct, consistent, and efficient analyses—particularly by non-experts. In particular, this complexity makes it difficult to know if a problem with or improvement to a server system exists, which resource indicators are important to a particular problem or improvement, and how a particular problem or improvement changes over time—particularly when one or many changes are made to a server system.

The number and variety of resource indicators often contributes to the complexity of an analysis through information overload. For example, non-experts can often have issues attempting to identify which resource indicators are important to their system and when they might be important or understanding their relation of one resource indicator to another over time or in response to changes. Due to the complexity, analysis is often cursory and inconsistent or requires expert monitoring of a server system over a period of time. For example, it is common for a server performance analysis to only consider the amount of processor utilized over a given period. Moreover, as a hedge to possible issues related to the health and performance of a server system, a client might select and use resources well in excess of those necessary to ensure a healthy service because it is overly complex to determine how many resources are required to carry out processes on a server system. However, oversizing of resources often results in substantially higher costs and likely masks and is ineffectual in preventing health and performance issues.

Currently, server performance and application health are supposedly monitored, to the extent they can be, using visual dashboards showing resource indicators for server systems. However, these visual dashboards often merely show the results of many resource indicators graphically and how they relate to independent thresholds and do not provide recommendations on or show what actions need to be implemented to solve an issue with or increase the health of a server system. Therefore, these visual dashboards leave it up to an individual, expert or not, to interpret and correlate those many resource indicators to determine the health and performance of a server system and determine any actions to take. Accordingly, there can be significant variability in the determination of the health and performance of a server system and what actions may make a server system better amongst individuals, even experts.

Moreover, most of these visual dashboards and analyses related to server systems do not consider or concern the health of the applications actually running on server machines, instead being only concerned with server machine resource capacities. Indeed, in cases where an application is running in a serverless architecture, where the server machines are operated and provisioned by a third-party provider, these visual dashboards might be close to useless as they are unable to give any accounting separate from the server machine itself. Accordingly, visual dashboards do not provide insight or actionable assistance when unhealthy applications on a server negatively affect that server's performance or when an application is running in a serverless architecture. Consequently, it would be advantageous to have a system and method that produces metrics to simplify measurement of the capacity and health of a server and the capacity and health of an application on a server, identifying potential problems, improvements, and solutions to increase performance, capacity and/or health and lower costs for operation of a server and application.

### BRIEF SUMMARY OF THE INVENTION

The present invention is directed to a server performance, capacity and application health management system and method that, in one or more aspects, improves performance, efficiency, and health and lowers costs for the operation of a server and application by producing simplified metrics showing the health, capacity and performance of a server and application system at any time and providing the means to identify potential problems, improvements, solutions, and recommended actions with respect to one or both of a server and application. In accordance with various embodiments, an application—such as SQL Server, MySQL, Oracle, Windows, PostgreSQL, Linux, and others—is executed on a server requiring server and application-allotted resources. Information about those resources and the application behavior is collected and transmitted through a network to a processing station to be accessed by a user through a computer, smartphone, or other electronic device.

The processing station uses a data analyzer, including a capacity algorithm logic unit and workload health algorithm logic unit, to generate capacity and workload health metrics from the information about a server. To generate the metrics, each of the capacity and workload health algorithm logic units include algorithms directed at producing a metric for a particular resource or behavior.

Capacity metrics may be generated for both the server and the application. The server capacity metrics can include those related to the use of server storage memory, server volatile memory, and a server processor. The application capacity metrics can include those related to application resource contention, the application processor, application storage memory, and application volatile memory. Metrics generated score the presence of resource pressure for the resource the metric concerns. For example, a particular score for a server volatile memory metric can indicate the use of a large amount of server volatile memory, reflecting that memory as unavailable to other applications and potentially hampering performance of the server.

Workload health metrics generated can include those related to code stability, resource predictability, and process predictability. The scores of these metrics indicate behavior related to the health of the application on the server. For example, an application with a particular process predictability score might have numerous instances of abnormal behavior or lack consistent patterned behavior all together over a period. As another example, an application with a particular code stability metric may indicate a particular segment of code is executing in an inefficient manner, leading to longer run times, such as in instances of code regression. Code regression can happen when code is executed based on reused cached data which is sub-optimal. For example, a navigation application might provide directions during rush hour based on a previously generated route that is sub-optimal at rush hour.

The metrics generated are displayed to a user providing simplified indicators of the performance and capacity of the server and the health of the application at a particular point, over time, including during changes to the server, application, or both, without complicated analysis of the server system, which may be difficult or impossible for non-experts. Additionally, the metrics can also consider changes over time to help identify, not only the performance, efficiency, and health of a server or application at a given instance, but over a period of time. Thereby, a user might not only identify specific instances of resource pressure but also how often those instances occur. Moreover, the capacity metrics generated for the server and application can also be used by the data analyzer to generate sizing recommendations, further simplifying an analysis. Additional recommendations related to specific actions or automatic actions can also be generated or initiated based on the metrics to improve server performance, server capacity, application capacity, or application health.

From the generated metrics and recommendations, a user may identify potential problems, improvements, and solutions regarding the system and application. The metrics and recommendations also provide for consistency among the conclusions regarding the performance and health of the server and application. Additionally, the metrics—particularly the capacity metrics—identify resource pressure, assisting with right sizing of a server and application. Moreover, the metrics assist users with seeing the effects of changes in a server or application, which may be useful when attempting to improve server and application operation. Graphical representations of the metrics over time may also be generated and presented to a user demonstrating the performance, efficiency, and health of a server and application over time, including the frequency of any resource pressure. Moreover, machine learning may be utilized with the generated metrics to find anomalies, patterns, and help predict future activities and requirements.

### BRIEF DESCRIPTION OF THE DRAWINGS

These and other features, aspects, and advantages of the present invention will become better understood with regard to the following description, appended claims, and accompanying drawings where:

FIG. 1A is a first portion of a simplified block diagram of an exemplary embodiment of a server performance and application health management system, according to the present disclosure;

FIG. 1B is a second portion of a simplified block diagram of an exemplary embodiment of a server performance and application health management system, according to the present disclosure;

FIG. 1C is a simplified block diagram of an exemplary embodiment of the user interface of a server performance and application health management system, according to the present disclosure;

FIG. 1D is a simplified block diagram of an exemplary embodiment of the capacity algorithm logic unit of a server performance and application health management system, according to the present disclosure;

FIG. 1E is a simplified block diagram of an exemplary embodiment of the workload health algorithm logic unit of a server performance and application health management system, according to the present disclosure;

FIG. 2 is a simplified flowchart of an exemplary embodiment of a method for using a server performance and application health management system, according to the present disclosure;

FIG. 3 is a simplified flowchart of an exemplary embodiment of the method for generating server capacity metrics, a portion of one embodiment of a method of using a server performance and application health management system, according to the present disclosure;

FIG. 4 is a simplified flowchart of an exemplary embodiment of the method for generating application capacity metrics, a portion of one embodiment of a method of using a server performance and application health management system, according to the present disclosure;

FIG. 5 is a simplified flowchart of an exemplary embodiment of the method for generating workload health metrics, a portion of one embodiment of a method of using a server performance and application health management system, according to the present disclosure;

FIG. 6 is a simplified flowchart of an exemplary embodiment of a method for using a server performance and application health management system including graphical diagrams, according to the present disclosure;

FIG. 7 is a simplified block diagram of an exemplary embodiment of a server performance and application health management system where the application is hosted in a serverless cloud computing environment, according to the present disclosure;

FIG. 7A is a simplified block diagram of an exemplary embodiment of the capacity algorithm logic unit of a server performance and application health management system in operation to manage an application in a serverless cloud computing environment, according to the present disclosure; and

FIG. 7B is a simplified block diagram of an exemplary embodiment of the workload health algorithm logic unit of a server performance and application health management system in operation to manage an application in a serverless cloud computing environment, according to the present disclosure.

### DETAILED DESCRIPTION OF THE INVENTION

With reference now to the drawings, a system and method for managing server performance and health of applications running thereupon—are herein described.

### Representative Embodiment of the Managing System Generally

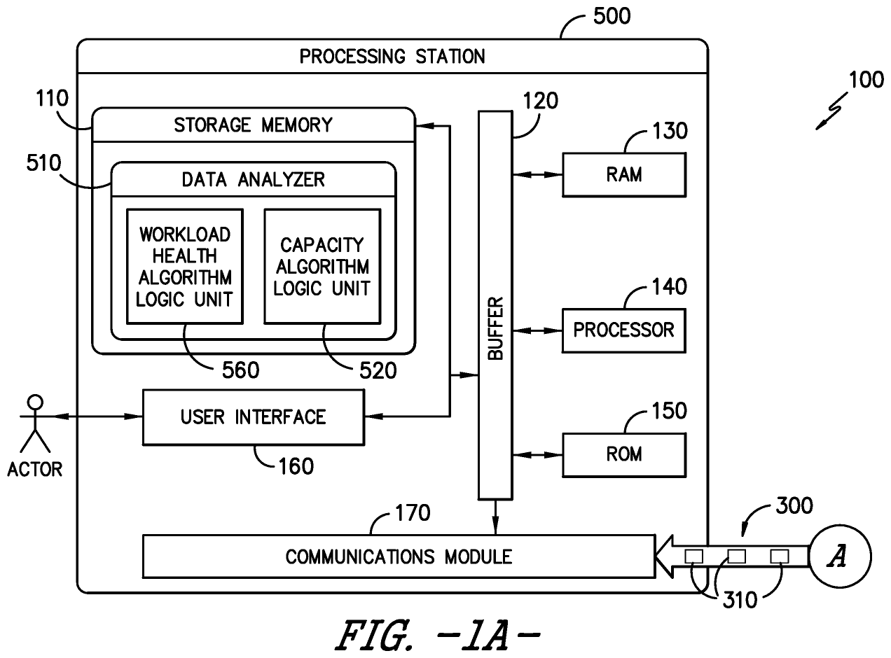

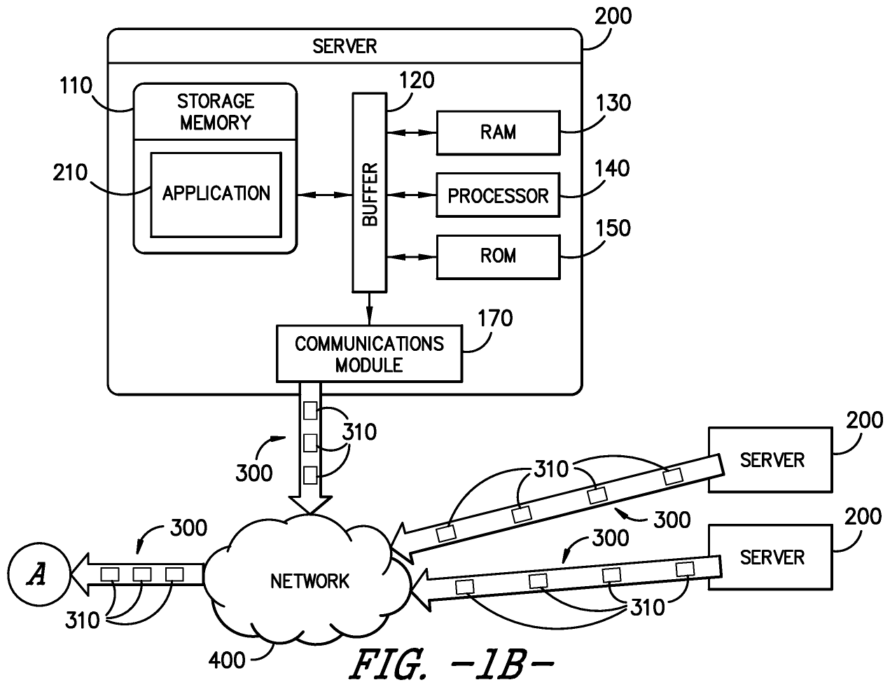

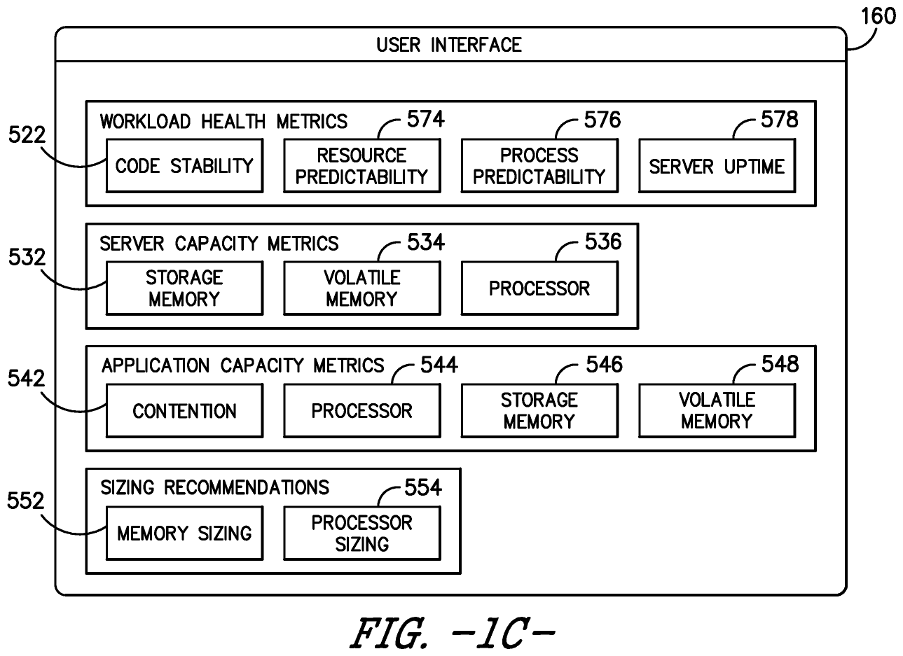

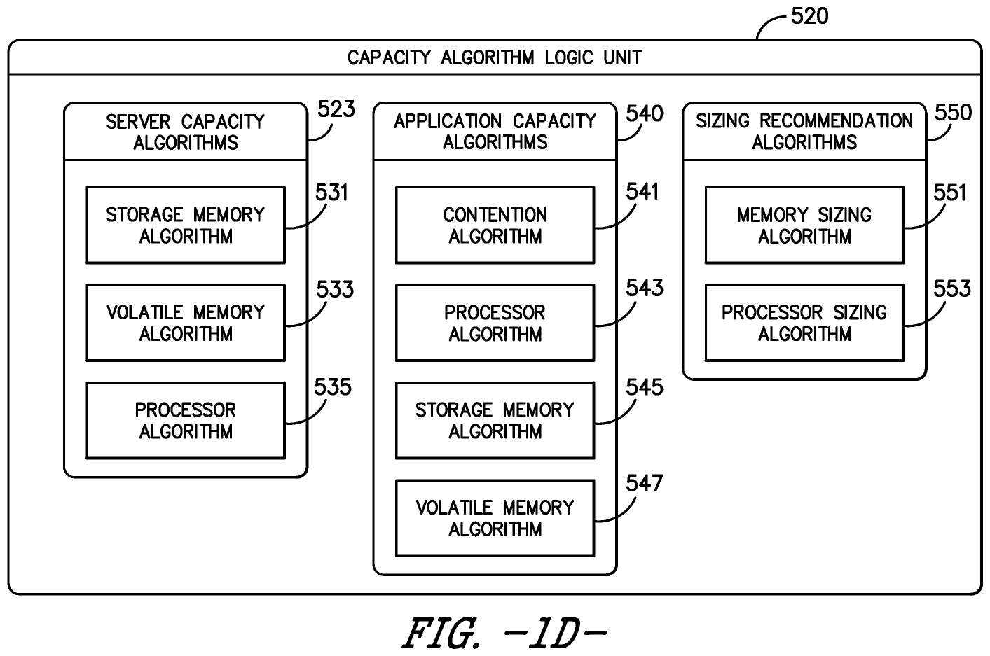

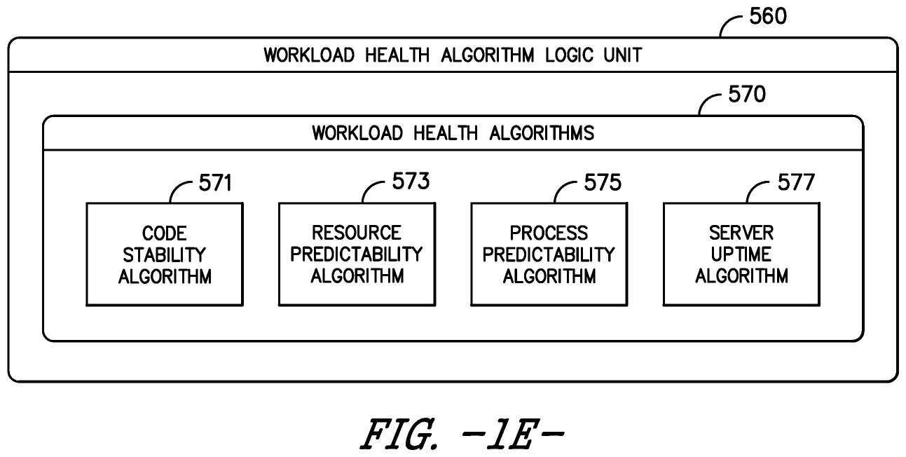

FIGS. 1A and 1B shows a simplified block diagram of an exemplary embodiment of a server performance and application health management system 100 wherein a server 200 and application 210 produce operation resource information 300 about the resources of the server 200 and application 210 and about the health of the application 210. Generally, the health of the application 210 is determined by the capacity, whether the application has all the physical and logic resources necessary to perform its functions, and the workload health, whether the application receives resources when requested, has consistent processing of requests, and can process the volumes of requests in an acceptable amount of time while being available to an end user.

Such operation resource information 300 is then sent, in packets 310, over a network 400 to a processing station 500. The processing station 500 utilizes a data analyzer 510 to apply server capacity algorithms 523, application capacity algorithms 540, sizing recommendation algorithms 550, and workload health algorithms 570 to the operation resource information 300 as in FIGS. 1D and 1E. Thereby, the data analyzer 510 generates various metrics including server capacity metrics (532, 534, 536), application capacity metrics (542, 544, 546, 548), sizing recommendation metrics (552, 554), and workload health metrics (572, 574, 576, 578), as indicated in FIG. 1C. These metrics may then be displayed to and used by an expert or non-expert user to identify problems, improvements, and solutions for a managed server 200.

### Portions of a Representative Embodiment of the Managing System

In the following section, the system 100 and portions thereof will be analyzed in more detail. As shown in FIG. 1, the system 100 is generally composed of a server 200, operation resource information 300, and a processing station 500.

### Server

As shown in FIGS. 1A and 1B, one embodiment of the server 200 comprises a computing device having storage memory 110, RAM 130, a processor 140, ROM 150, and a communications module 170 connected together via a buffer 120. Further, it is contemplated that components may be removed or added in other embodiments and that components may be connected together in other ways. However, it is foreseen that the server 200 of the present invention will comprise non-volatile storage memory, volatile memory, processing, and communications resources no matter the composition and arrangement.

Additionally, the server 200 also comprises at least one application 210. A non-exhaustive list of application examples includes SQL Server, MySQL, Oracle, Windows, PostgreSQL, and Linux. Although examples are provided for applications, it is foreseen that other applications may be utilized. As shown in FIG. 1, the application 210 will generally be stored in storage memory 110 and make use of the server 200 resources to perform one or more tasks when executed. For example, SQL Server may utilize the storage memory 110 and RAM 130 allotted to it to create, maintain, and return information from a database on the server 200.

### Operation Resource Information

As shown in FIGS. 1A and 1B, operation resource information 300 in one embodiment is transmitted from servers 200 to a processing station 500 via packets 310 through a network 400. Generally, operation resource information 300 comprises data regarding the use of the resources of the server 200 and execution of the application 210. In one embodiment, the operation resource information 300 comprises information regarding the amount of storage memory 110, RAM 130, and processor 140 of a server being utilized during a particular period of application 210 execution. The operation resource information 300 may also include the amount of storage memory 110, RAM 130, and processor 140 being utilized specifically by the application 210 and the amount of resource contention caused by execution of the application 210 during a period.

Additionally, it is foreseen that the operation resource information 300 may include additional, potentially relevant data, such as the total amount of storage memory 110, volatile memory, and processor 140 power for the server 200 or allotted specifically to the application 210. Moreover, the operation resource information 300 may include the relevant time period for any data provided. While FIG. 1 shows operation resource information 300 sent in packets 310, it is also foreseen that operation resource information 300 may be sent in other formats, such as a stream along a dedicated routing path through a network.

### Network

As also shown in FIG. 1B, the operation resource information 300 is transmitted to the processing station 500 through a network 400. The network 400 may be any feasible means of communication between the communications modules 170 of the server 200 and the processing station 500. For example, the network 400 may include one or more of personal, local, wireless local, campus, metropolitan, wide, storage, system, and passive optical local area networks and enterprise and virtual private networks. Additionally, the network 400 may make use of various wired and wireless data standards, such as ethernet, fiber optical, Wi-Fi and cellular. It is foreseen that the network 400 may also involve cloud networking, such as passing data through various cloud-based resources and services. These cloud-based resources and services may amend or change the operation resource information 300 to reformat or add additional data. For example, operation resource information 300 may be sent to a cloud-based search and analytics engine to prepare and format data to be sent to the processing station 500.

### Processing Station

Further, in one embodiment, the processing station 500 comprises a computing device having storage memory 110, RAM 130, a processor 140, ROM 150, a user interface 160, and a communications module 170 connected together via a buffer 120, as shown in FIG. 1A. Further, it is contemplated that components may be removed or added in other embodiments and that components may be connected together in another manner. While the components of the processing station 500 are shown to reside on one computing device in FIG. 1A, it is foreseen that one or more components may reside on another computing device. For example, in certain embodiments, the user interface 160 may be located on an electronic device connected to a cloud-based server having the remaining relevant components of the processing station 500. Indeed, if the various metrics are displayed to a user through a web-portal, the user interface 160 may comprise a device accessing the web portal itself while the data analyzer 510 is located in the memory 110 of a remote server such as that hosting the website or a database storing the metrics to be accessed by the website.

As shown in FIG. 1C, the User Interface 160 can present a number of various workload health metrics, server capacity metrics, application capacity metrics, and sizing recommendations. As shown, the workload health metrics can include metrics for code stability 572, resource predictability 574, process predictability 576, and server uptime 578. Similarly, the server capacity metrics can include those for storage memory 532, volatile memory 534, and the server processor 536. Further, the application capacity metrics can include those for application resource contention 542, the application processor 544, storage memory 546, and volatile memory 548. Likewise, the sizing recommendations can include those for memory sizing 552 and processor sizing 554. These metrics, as described previously can be calculated utilizing associated server workload health 570, server capacity 523, application capacity 540, and sizing recommendation algorithms 550, such as those indicated in FIGS. 1D and 1E.

### Data Analyzer

As shown in FIG. 1A, the data analyzer 510 may be located on the storage memory 110 of the processing station 500 and comprises two logic units, the capacity algorithm logic unit 520 and workload health algorithm logic unit 560, which apply algorithms to the operation resource information 300 received from a server 200. Generally, the capacity algorithm logic unit 520 is concerned with the calculation of metrics related to the capacity of the server and the application and the workload health algorithm logic unit 560 is concerned with the calculation of metrics related to the health of the application 210 on a server 200.

### Capacity Algorithm Logic Unit

In particular to the capacity algorithm logic unit 520, FIG. 1D provides a simplified block diagram of the algorithms composing such. These algorithms include server capacity algorithms 523—such as the algorithms for storage memory 531, volatile memory 533, and server processor 535—application capacity algorithms 540—such as the algorithms for application resource contention 541, application processor 543, storage memory 545, and volatile memory 547—and the sizing recommendation algorithms 550—such as the algorithms for memory sizing 551 and processor sizing 553.

Regarding the server capacity algorithms 523, the storage memory algorithm 531 considers and generates a metric 532 reflecting the use of storage memory 110 on the server 200 relative to the total storage memory 110 capacity available for a period of time. Similarly, the volatile memory algorithm 533 considers and generates a metric 534 reflecting the use of volatile memory, such as RAM 130, relative to the total volatile memory capacity available for a period of time. Likewise, the processor algorithm 535 considers and generates a metric 534 reflecting the use of the processor 140 relative to the total processing power available for a period of time.

Regarding the application capacity algorithms 540, the application resource contention algorithm 541 considers and generates a metric 542 reflecting application resource contention, e.g., delay of application resources when the application requires them, during execution of the application for a period of time. For example, the application resource contention metric 542 may be calculated for a SQL Server based on the amount of blocking of one or more resources occurs when an application process, such as a SQL query, needs access to such resources to execute and has to wait. The application processor algorithm 543 considers and generates a metric 544 reflecting the status of the application processor for a period of time. For example, the application processor metric 544 may consider if a SQL Server processor has many threads suspended and waiting for a resource in a waiter list or long runnable queues. Moreover, the storage memory algorithm 545 considers and generates a metric 546 reflecting the use of storage memory 110 relative to the total storage memory 110 assigned to an application 210 for a period of time. Similarly, the volatile memory algorithm 547 considers and generates a metric 548 reflecting the use of volatile memory, such as RAM 130, relative to the total volatile memory assigned to an application 210 for a period of time.

The proceeding metrics generated by the server capacity algorithms 523 and application capacity algorithms 540 provide a non-expert with a meaningful and detailed indication of the state of various server and application assigned resources, i.e., capacity. In the case where the metrics are numbers and the higher number indicates a higher level of the measured resource in use or a higher level of subject activity, a higher number for a metric may indicate resource pressure related to the item or activity being measured. For example, a high number for the application processor metric 544 may indicate additional processing resources should be assigned to an application 210 to prevent additional wait times. Similarly, a high number for server storage memory metric 532 may indicate additional storage memory 110 is required and should be installed or some of the stored data needs to be relocated from the server 200 to another server.

In order to simplify the metrics further, for experts and non-experts, the capacity algorithm logic unit 520 may include sizing recommendation algorithms 550, including a memory sizing algorithm 551 to produce a memory sizing metric 552 and processor sizing algorithm 553 to produce a processor sizing metric 554 to further abstract whether the server/application has resource pressure for its memory and processor resources over a period of time. Each of these metrics 552,554 may consider one or more of the previously calculated server and application capacity metrics to conclude if a resource is oversized, undersized, or right sized.

Moreover, while the metrics have been described as being numbers or indicators, it is foreseen that one or more graphical diagrams may be utilized to easily demonstrate the activity of one or more metrics over time. The graphical diagrams may be particularly helpful to provide an indication relative to activities occurring on the server 200 at a particular point in time. For example, if a graphical diagram for the server processor metric 536 demonstrates that processor 140 resource pressure occurs every day at noon, a user may use that information to investigate what activity the server 200 is engaged in at noon, the first step in determining if a solution or improvement exists. Moreover, analysis of activity and patterns in the above metrics during the operation of a server 200 and application 210 thereon over time can also provide for optimization of the required resources, such as capacity for both the server 200 and application 210. As an aid to analysis of the above metrics, machine learning may be utilized to find anomalies, patterns, and help predict future activities and requirements. For example, machine learning might help identify patterns in resource pressure indicated through the server capacity algorithms 523 or application capacity algorithms 540 indicating that capacity should be increased during a certain period to account for resource pressure according to the pattern.

### Workload Health Algorithm Logic Unit

In particular to the workload health algorithm logic unit 560, FIG. 1E provides a simplified block diagram of the algorithms composing such. These include workload health algorithms 570 including algorithms for code stability 571, resource predictability 573, process predictability 575, and server uptime 577. One or more of the algorithms comprising the workload health algorithm logic unit 560 may be trained through machine learning, such as by the process shown in FIG. 8—discussed further below.

Regarding the workload health algorithms 570, the code stability algorithm 571 considers and generates a metric 572 reflecting the effectiveness of application 210 code over a specified time without inefficiencies, such as plan regression events. A plan regression event occurs when an application 210, such as a SQL Server, uses a sub-optimal past plan to carry out a task, such as a query. For example, when a query is executed by a SQL Server, a SQL plan is created and cached to be reused on that query again. However, this plan may not always be optimal for the same query, particularly when parameters are changed. In such cases, the sub-optimal plan leads to inefficient execution and longer run times. The code stability metric 572, therefore, can indicate how prevalent inefficiencies, like code regressions, are for a period of time. For example, the code stability algorithm 571 might calculate a metric 572 of 90% over a period when 10% of the code executed results in inefficiencies and delays, such as those due to plan regression.

The resource predictability algorithm 573 considers and generates a metric 574 reflecting the availability of a requested resource or service without delays over a specified time. Examples of resources and services that can be requested include access to storage memory, RAM, inputs, outputs, and resource locks. The resource predictability metric 574, therefore, can indicate how prevalent delaying wait times are for a requested resource or service over a period of time. For example, the resource predictability algorithm 573 might calculate a metric 574 of 57% over a period when 43% of requests for resources or services include delaying wait times.

The process predictability algorithm 575 considers and generates a metric 576 reflecting the amount of work performed by the server 200 within a typical range over a specified time without anomalous instances of work requirements outside the range. The process predictability metric 576, therefore, can indicate how normal, i.e., regular, the work the server 200 is performing over a period of time. For example, the process predictability algorithm 575 might calculate a metric 576 of 98% over a period when the server 200 performed an abnormally large number of queries for 2% of the period, potentially due to abnormally high user request activity.

The server uptime algorithm 577 considers and generates a metric 578 reflecting the amount of time that the server 200 has been successfully operational, i.e., working, versus downtime over a period. For example, the server uptime algorithm 577 might calculate a metric 578 of 99% over a period when the server 200 has been down or nonoperational for less than 1% of the time during the period.

The proceeding metrics generated by the workload health algorithms 570 provide a non-expert with a meaningful and detailed indication of the health of application activity, i.e., workload. In the case where the metrics are numbers and the higher number indicates a higher level of the subject activity, a higher number for a metric may indicate a healthy workload for an application. Moreover, while the workload health metrics have been described as being numbers or percentages, it is foreseen that one or more graphical diagrams may be utilized to easily demonstrate the activity of one or more metrics over time. The graphical diagrams may be particularly helpful to provide an indication of the effect of alterations to the server 200 or application 210 over a period of time. For example, if a diagram indicated that all the metrics increased after a change to the server 200 or application 210, it would indicate that the change has made the server 200 and application 210 more stable, predictable, and reliable.

Moreover, analysis of activity and patterns in the workload heath algorithm metrics during the operation the application 210 over time can also provide for a more educated analysis of workload health. As an aid to analysis of the workload heath algorithm metrics, machine learning may be utilized to find anomalies, patterns, and help predict future activities and requirements. For example, machine learning might help identify patterns in code stability, including any code regressions, indicating how efficient the code of the application is.

### Method of Managing System Performance and Application Health Generally

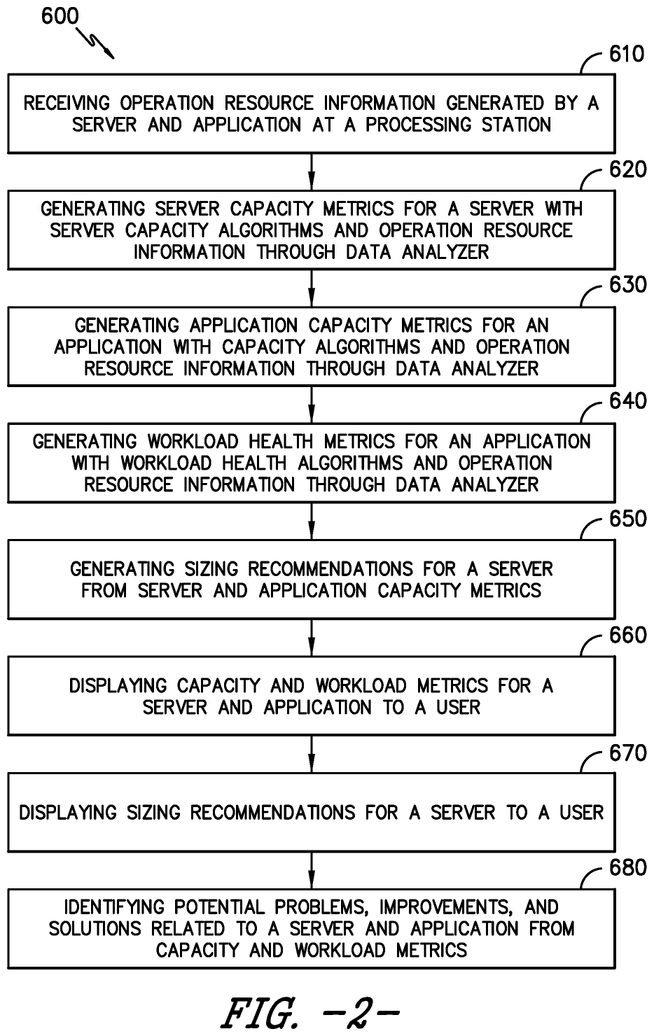

FIG. 2 is a simplified flow chart of an exemplary embodiment of a method 600 of managing server performance and application health. The method begins with step 610 where a processing station 500 receiving operation resource information 300 generated by a server 200 and application 210. Thereafter, the method comprises generating server capacity metrics 620, application capacity metrics 630, and workload health metrics 640 from operation resource information 300 and server capacity algorithms 523, application capacity algorithms 540, and workload health algorithms 570. Additionally, the method contemplates generating sizing recommendations 650 from the server and application capacity metrics. Thereafter, the metrics and sizing recommendations are displayed to the user 660, 670 and used to identify potential problems, improvements, and solutions 680.

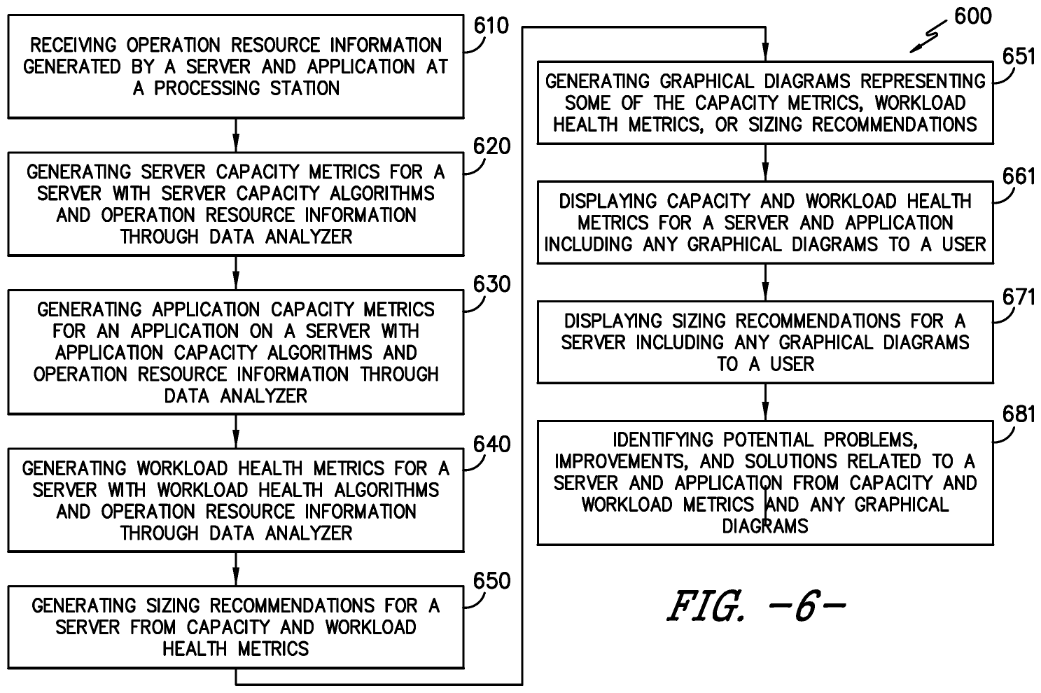

Similar to the above, FIG. 6 is a simplified flow chart of an additional exemplary embodiment of a method 601 of managing server performance and application health. However, unlike FIG. 2, the method also includes generating graphical diagrams of some or all of the capacity metrics, workload health metrics, and sizing recommendations 651. These graphical diagrams are displayed along with the capacity and workload health metrics 661 and sizing recommendations 671, if created. Also, any graphical diagrams are also utilized in identifying potential problems, improvements, and solutions 681.

It is to be understood that, as part of the step of identifying potential problems, improvements, and solutions 680, 681, the processing station 500 may generate recommended actions for a server 200 or application 210 based on metrics generated. For example, the metrics generated may demonstrate a pattern indicating times when a server 200 is less busy and recommend that activity from a busier time, such as a time when the server 200 or application 210 regularly registers resource pressure, be scheduled during the less busy time. As an aid to the generation of recommendations, machine learning may be employed to find anomalies and patterns indicative of a recommended action.

### Generating Server Capacity Metrics

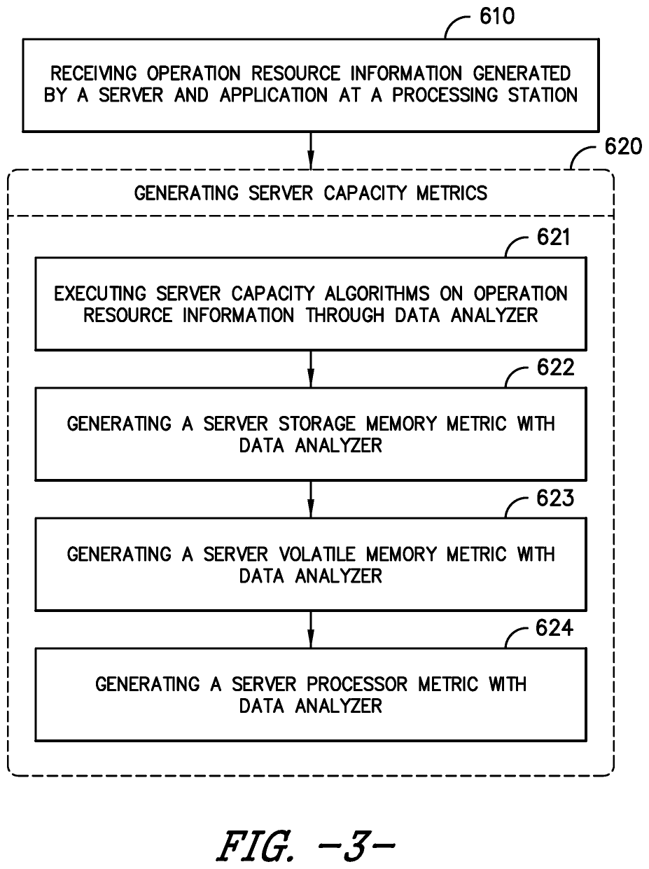

FIG. 3 shows a simplified flow chart of an exemplary embodiment specific to the method of generating server capacity metrics comprising step 620. As an initial matter, the method contemplates receipt of the operation resource information 610, upon which server capacity algorithms 523 are executed 621. As a result of the execution 621, the data analyzer 510 generates a server storage memory metric 622, a server volatile memory metric 623, and a server processor metric 624. Therefore, the exemplary method of generating server capacity metrics 620 results in metrics for server storage memory 532, volatile memory 534, and processor usage 536 which can be later displayed to a user 660 and used, along with application capacity metrics, to generate sizing recommendations 650, as in FIG. 2.

### Generating Application Capacity Metrics

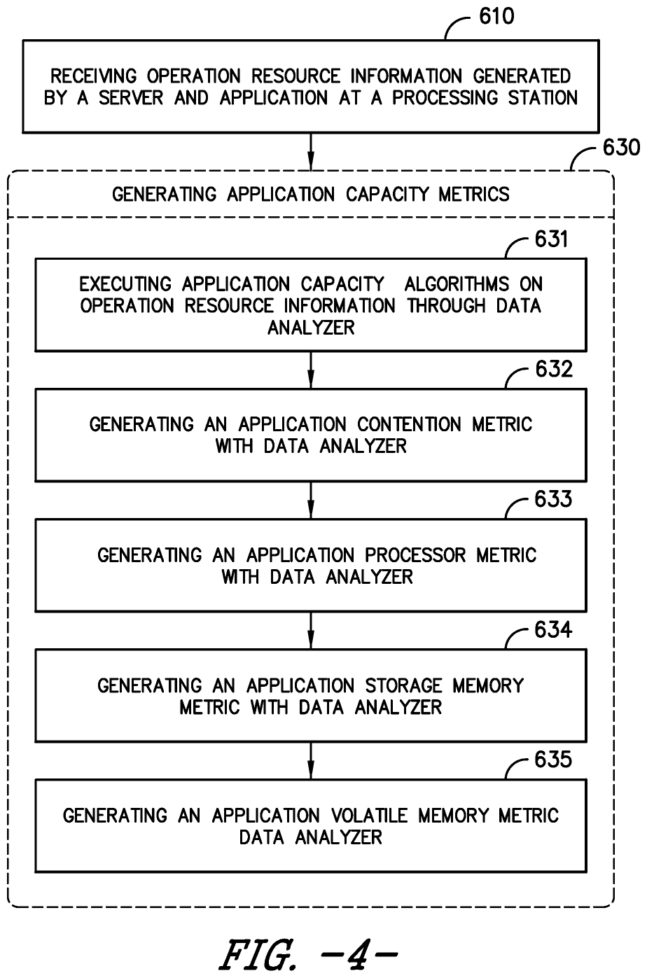

FIG. 4 shows a simplified flow chart of an exemplary embodiment specific to the method of generating application capacity metrics comprising step 630. As an initial matter, the method contemplates receipt of the operation resource information 610, upon which application capacity algorithms 540 are executed 631. As a result of the execution 631, the data analyzer 510 generates an application resource contention metric 632, an application processor metric 633 an application storage memory metric 634, and an application volatile memory metric 635. Therefore, the exemplary method of generating application capacity metrics 630 results in metrics for application resource contention 542, application processor 544, application storage memory 546, and application volatile memory 548 which can be later displayed to a user 660 and used, along with server capacity metrics, to generate sizing recommendations 650, as in FIG. 2.

### Generating Workload Health Metrics

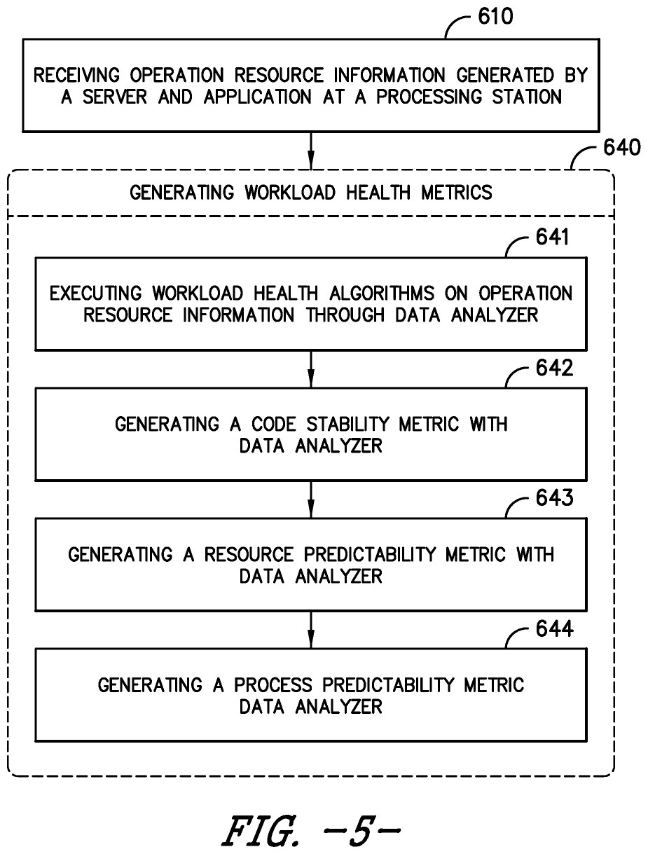

FIG. 5 shows a simplified flow chart of an exemplary embodiment specific to the method of generating workload health metrics comprising step 640. As an initial matter, the method contemplates receipt of the operation resource information 610, upon which workload health algorithms 570 are executed 641. As a result of the execution 641, the data analyzer 510 generates a code stability metric 642, a resource predictability metric 643, and a process predictability metric 644. Therefore, the exemplary method of generating workload health metrics 640 results in metrics for code stability 572, resource predictability 574, and process predictability 576 which can be later displayed to a user 660, as in FIG. 2.

### System and Method Benefit

Generation of the earlier described metrics related to server 200 performance and application 210 health provide useful data to a user, particularly a non-expert, in identifying problems, improvements, and solutions related to a server 200 and application 210. In particular, the metrics provided are particularly useful in determining whether there is resource pressure and which resource is at issue. Likewise, the metrics provided are also particularly useful in determining whether a particular server 200 is right sized for the application 210 and its use, including whether the server 200 is oversized. Thereby, a user could easily understand if shrinking the resources of the server 200 would result in a cost savings without unintended problems. Moreover, the metrics, particularly the workload health metrics, are useful in identifying the results of changes made to the server 200 and application 210. Thereby, a user could easily see improvements in the performance of a server 200 and health of an application 210 over a period, quantifying the benefit of the improvements.

Similarly, it is to be understood that the present system 100 and method 600 provide a particular utility to the expert and non-expert by allowing the utilization of fewer metrics to analyze server performance and application health. The use of fewer metrics in the present system 100 and method 600 relieve information overload. Additionally, the use of fewer metrics also allows for more consistent conclusions among expert and non-expert users regarding server performance and application health. Indeed, there are a very large variety of metrics which may be used with various different thresholds and views (e.g., exponential, logarithmic) and no single metric can definitively show the health of a system involving a server or application. Moreover, while the system 100 and method 600 generate fewer metrics for a user to draw conclusions from, the metrics and their relationships are better understood mitigating the risk of monitoring and analysis becoming cursory and incomplete.

### Alternative Embodiments

While a representative embodiment of the management system 100 been described as including a server 200 and application 210, it is foreseen that the management system 100 may also be utilized in circumstances involving only a server 200 or a serverless application 210. In a server only embodiment, the management system 100 would utilize server capacity algorithms 523 to determine metrics on the performance of the server. Moreover, the system 100 could also still utilize the sizing recommendation algorithms 550. However, the system 100 would not require algorithms related to applications, such as those of the application capacity algorithms 540, and the code stability algorithm 571 and process predictability algorithm 575 of the workload health algorithms 570.

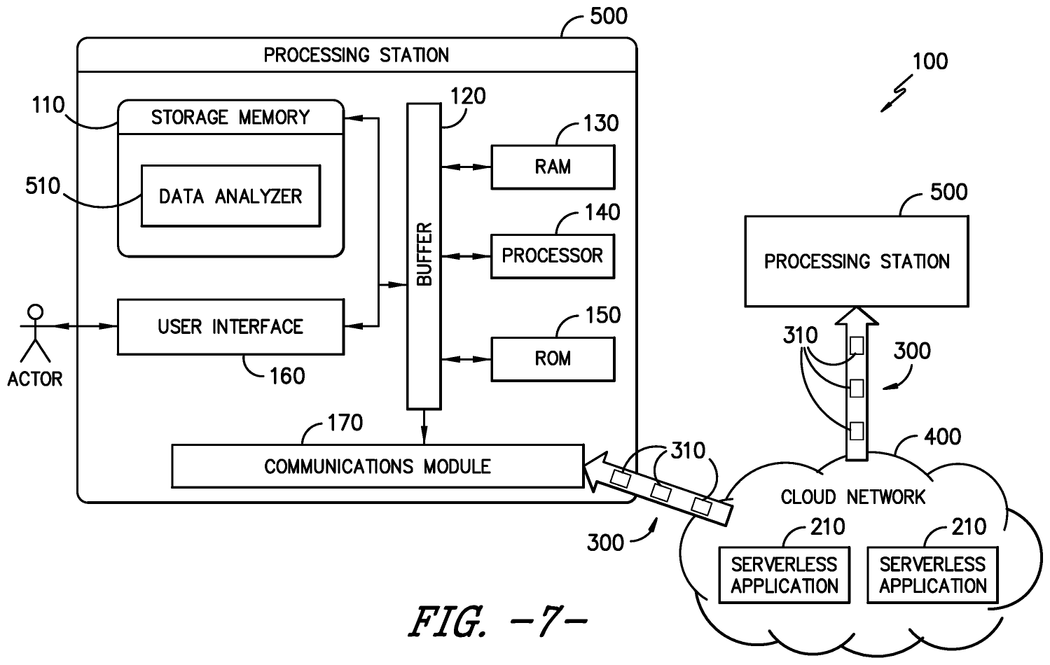

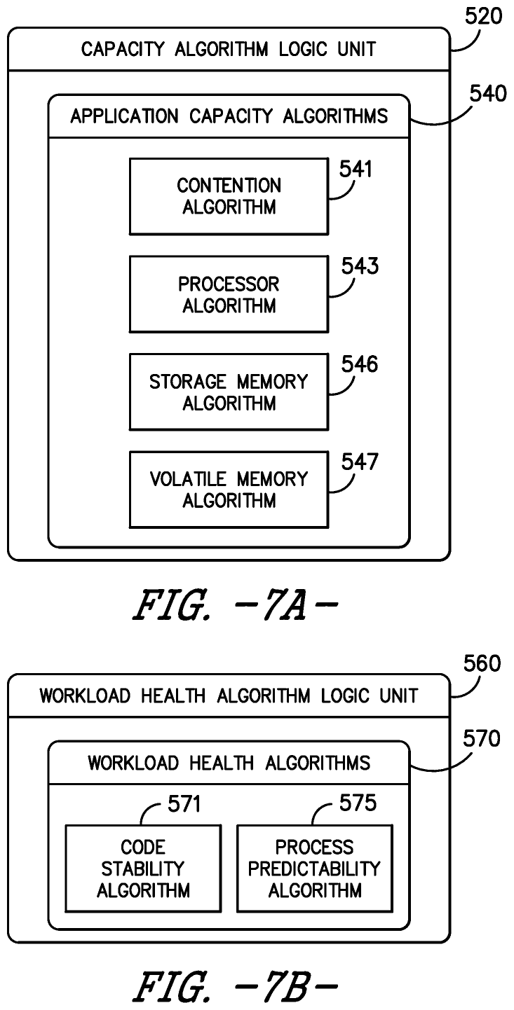

In an alternative situation, when the system 100 is utilized in circumstances involving a serverless application 210, the system may utilize the application capacity algorithms 540 and the code stability algorithm 571 and the process predictability algorithm 575 of the workload health algorithms 570 as shown in FIGS. 7A and 7B. Generally, the system 100 would not require algorithms related to the server 200, as the application 210 is serverless. Please note, the term serverless used herein does not necessarily mean that there is no server involved in the process, but that any server is managed by a third-party provider. FIG. 7 shows a generalized architecture of an example embodiment where processing stations 500 receive operation resource information 300 from serverless applications 210. The processing station 510 uses the operation resource information 300 and data analyzer 510 to create and user interface 160 to display workload health metrics and application capacity metrics. Thereby, the system 100 may be utilized to manage a service (serverless application 210), a server 200, or a server 200 with one or more applications 210

Moreover, while several embodiments have indicated a single processing station 500, server 200, or application 210, it is foreseen that the above-described system 100 can have more than one of any identified elements and combine elements of various embodiments. For example, in one embodiment the system 100 may include two or more processing stations 500 to manage hundreds of servers 200, some with applications 210 and some without, and a number of applications 210 in a serverless architecture, such as being hosted in a cloud networking environment. Indeed, it is foreseen that any of the metrics generated for a single server 200 or application 210, whether on a server 200 or not, could be aggregated to create metrics for a grouping of servers 200 or applications 210 for any time periods.

The term “comprises”, and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Although the present invention has been described in considerable detail with possible reference to certain preferred versions thereof, other versions are possible. Therefore, the spirit and scope of the appended claims should not be limited to the description of the preferred versions contained herein. All features disclosed in this specification may be replaced by alternative features serving the same, equivalent, or similar purpose, unless expressly stated otherwise. Thus, unless expressly stated otherwise, each feature disclosed is one example only of a generic series of equivalent or similar features. Further, it is not necessary for all embodiments of the invention to have all the advantages of the invention or fulfill all the purposes of the invention.

In the present description, the claims below, and in the accompanying drawings, reference is made to particular elements of the invention. It is to be understood that the disclosure of the invention in this specification includes all possible combinations of such particular elements. For example, where a particular element is disclosed in the context of a claim, that element can also be employed, to the extent possible, in aspects and embodiments of the invention, and in the invention generally.

Also, although the description above contains many specificities, these should not be construed as limiting the scope of the embodiments but as merely providing illustrations of some of several embodiments. Thus, the scope of the embodiments should be determined by the appended claims and their legal equivalents, rather than by the examples given.

What is claimed is:

1. A management system, comprising:
a first server comprising a first storage memory, a first working memory, a first processor, and a first communications module;
at least one resident application stored in said first storage memory and executed through said first processor and said first working memory on said first server;
a processing station comprising a second storage memory, a second working memory, a second processor, and a second communications module, wherein said first and second communications modules are networked together;
operation resource information generated by said first server and said at least one resident application during execution and transmitted through said first communications module to said second communications module;
a data analyzer stored in said second storage memory comprising a capacity algorithm logic unit;
server capacity metrics generated by said capacity algorithm logic unit from said operation resource information comprising metrics for at least one of said first storage memory, said first working memory, and said first processor;
application capacity metrics generated by said capacity algorithm logic unit from said operation resource information comprising metrics regarding at least one of said resident application resource contention, application processor, storage, and memory; and
whereby said server and application capacity metrics provide data on said first server and said resident application to allow for an analysis regarding potential problems, improvements, and solutions related to said first server and said resident application and a simplified presentation of said analysis results.

2. The management system of claim 1, further comprising:
a second server comprising a third storage memory including an additional resident application, a third working memory, a third processor, and a third communications module;
operation resource information transmitted by said third communications module to said second communications module; and
additional server capacity metrics and additional application capacity metrics generated by said capacity algorithm logic unit.

3. The management system of claim 1, further comprising:
sizing recommendations generated by said data analyzer to determine if sizing changes in memory would benefit said first server.

4. The management system of claim 1, wherein said data analyzer further comprises a workload health algorithm logic unit and workload health metrics generated by said workload health algorithm logic unit include one or more of code stability, resource predictability, process predictability, and server uptime.

5. The management system of claim 1, further comprising:
recommendations generated by said data analyzer based on one or more of patterns and anomalies identified through machine learning analysis of one or more metrics generated by said capacity algorithm logic unit.

6. The management system of claim 4, further comprising:
recommendations generated by said data analyzer based on one or more patterns and anomalies identified through machine learning analysis of one or more workload health metrics.

7. The management system of claim 1, further comprising:
recommendations generated by said data analyzer based on one or more metrics generated by said data analyzer.

8. A management system, comprising:
a first server comprising a first storage memory, a first working memory, a first processor, and a first communications module;
a processing station comprising a second storage memory, a second working memory, a second processor, and a second communications module, wherein said first and second communications modules are networked together;
operation resource information generated by said first server and transmitted through said first communications module to said second communications module;
a data analyzer stored in said second storage memory comprising a capacity algorithm logic unit;
server capacity metrics generated by said capacity algorithm logic unit from said operation resource information comprising metrics for at least one of said first storage memory, said first working memory, and said first processor; and
whereby said server capacity metrics provide data on said first server to allow for an analysis regarding potential problems, improvements, and solutions related to said first server and a simplified presentation of said analysis results.

9. The management system of claim 8, further comprising:
sizing recommendations generated by said data analyzer to determine if sizing changes in memory would benefit said first server.

10. The management system of claim 8, wherein said data analyzer further comprises a workload health algorithm logic unit and workload health metrics generated by said workload health algorithm logic unit include one or more of resource predictability and server uptime.

11. The management system of claim 8, further comprising:
recommendations generated by said data analyzer based on one or more of patterns and anomalies identified through machine learning analysis of one or more metrics generated by said capacity algorithm logic unit.

12. The management system of claim 10, further comprising:
recommendations generated by said data analyzer based on one or more of patterns and anomalies identified through machine learning analysis of one or more workload health metrics.

13. The management system of claim 8, further comprising:
recommendations generated by said data analyzer based on one or more metrics generated by said data analyzer.

14. A management system, comprising:
an application stored in a remote network accessible location;
a processing station comprising a communications module, wherein said communications module can transmit and receive data from said application through said network;
operation resource information generated by said application during execution and transmitted through said network to said communications module;
a data analyzer stored in said second storage memory comprising a capacity algorithm logic unit;
application capacity metrics generated by said capacity algorithm logic unit from said operation resource information comprising metrics regarding at least one of application resource contention, application processor, storage, and memory; and
whereby said server and application capacity metrics provide data on said first server and said resident application to allow for an analysis regarding potential problems, improvements, and solutions related to said first server and said resident application and a simplified presentation of said analysis results.

15. The management system of claim 14, further comprising:
sizing recommendations generated by said data analyzer to determine if sizing changes in memory would benefit said application.

16. The management system of claim 14, wherein said data analyzer further comprises a workload health algorithm logic unit and workload health metrics generated by said workload health algorithm logic unit include one or more of code stability and process predictability.

17. The management system of claim 14, further comprising:
recommendations generated by said data analyzer based on one or more of patterns and anomalies identified through machine learning analysis of one or more metrics generated by said capacity algorithm logic unit.

18. The management system of claim 16, further comprising:
recommendations generated by said data analyzer based on one or more of patterns and anomalies identified through machine learning analysis of one or more workload health metrics.

19. The management system of claim 14, further comprising:
recommendations generated by said data analyzer based on one or more metrics generated by said data analyzer.
